(19) United States
(12) Patent Application Publication
(10) Pub. No.: US 2024/0316548 A1
(43) Pub. Date: Sep. 26, 2024

(54) SEMICONDUCTOR SENSING CHIP AND MICROFLUIDICS SENSING SYSTEM

(71) Applicant: National Taiwan University, Taipei (TW)

(72) Inventors: Jun-Chau Chien, Taipei (TW); Shu-Yan Chuang, Taipei (TW); Yan-Ting Hsiao, Taipei (TW); Hung-Yu Hou, Taipei (TW); Yun-Chun Su, Taipei (TW)

(73) Assignee: National Taiwan University, Taipei (TW)

(21) Appl. No.: 18/613,159

(22) Filed: Mar. 22, 2024

Related U.S. Application Data
(60) Provisional application No. 63/454,294, filed on Mar. 23, 2023.

(51) Int. Cl. B01L 3/00; G01N 27/414

(52) U.S. Cl. CPC B01L 3/502715; B01L 3/502761; G01N 27/4145; G01N 27/4148; B01L 2200/16; B01L 2300/0636; B01L 2300/0645; B01L 2300/0809; B01L 2300/0864; B01L 2300/0877; B01L 2300/0883; B01L 2400/0457

(57) ABSTRACT

Disclosed are a semiconductor sensing chip and a microfluidic sensing system. The microfluidics sensing system includes a first inlet and a second inlet, a fluidic structure, and a semiconductor sensing chip. The first inlet and the second inlet are respectively configured for injection of a sample and a reagent. The fluidic structure is coupled to the first inlet and the second inlet. The fluidic structure is configured to mix the sample and the reagent to generate a biofluid under test. The semiconductor sensing chip is disposed at the end of the fluidic structure and configured to sense the biofluidic under test and generate a concentration sensing result corresponding to the sample.

### CROSS-REFERENCE TO RELATED APPLICATION

This application claims the priority benefit of U.S. provisional application Ser. No. 63/454,294, filed on Mar. 23, 2023. The entirety of the above-mentioned patent application is hereby incorporated by reference herein and made a part of this specification.

### BACKGROUND

### Field of the Disclosure

The present disclosure relates to a chip and a system, and in particular, to a semiconductor sensing chip and a microfluidics sensing system.

### Description of Related Art

In existing detection technology, although a large-scale detection device is able to achieve high accuracy, it is difficult to apply the large-scale detection device commonly in every service endpoint for point-of-care (POC) inspections due to the high cost of such detection device. In addition, although general test strips are relatively cheap, generally they are only able to provide binary test results. Therefore, how to design a detection device that is able to provide accurate detection results at a relatively low cost has become one of the challenges for modern medical care.

### SUMMARY

The present disclosure provides a semiconductor sensing chip and a microfluidics sensing system, which utilizes reflow channel structures and semiconductor sensing chips from different fields, and thus are able to provide accurate detection results at a relatively low cost.

The microfluidics sensing system of the present disclosure includes a first inlet and a second inlet, a fluidic structure and a semiconductor sensing chip. The first inlet and second inlet are configured for injection of a sample and a reagent respectively. The fluidic structure is coupled to the first inlet and the second inlet. The fluidic structure is configured to mix the sample and the reagent to generate a biofluid under test. The semiconductor sensing chip is disposed at the end of the fluidic structure and is configured to sense the biofluid under test and generate a concentration sensing result corresponding to the sample.

The semiconductor sensing chip of the present disclosure is configured to sense the biofluid under test. The semiconductor sensing chip includes a metal carrier and a readout circuit. The metal carrier has a sensing electrode. The metal carrier is configured to carry the biofluid under test and sense the biofluid under test through the sensing electrode to obtain sensing signals. The readout circuit is configured to accumulate sensing signals within a preset time interval to generate an accumulation result. The readout circuit generates the concentration value corresponding to the biofluid under test based on the accumulation result.

Based on the above, the present disclosure may perform sensing in an accumulative manner through the overall structural configuration of the microfluidics sensing system and the readout circuit in the semiconductor sensing chip, thereby effectively reducing costs and achieving miniaturization while realizing output with high accuracy.

### BRIEF DESCRIPTION OF THE DRAWINGS

FIG. 1 illustrates a schematic diagram of a microfluidics sensing system according to an embodiment of the present disclosure.

FIG. 2A and FIG. 2B are schematic diagrams showing the principle of CRISPR binding to single-stranded DNA for detecting target biomolecules.

FIG. 3 is a circuit diagram of a semiconductor sensing chip according to an embodiment of the present disclosure.

FIG. 4 is a circuit diagram of a digital-to-analog converter according to an embodiment of the present disclosure.

FIG. 5 is a circuit diagram of an amplifier according to an embodiment of the present disclosure.

FIG. 6 is a circuit diagram of an amplifier according to an embodiment of the present disclosure.

FIG. 7 is a circuit diagram of a switch according to an embodiment of the present disclosure.

FIG. 8 is a circuit diagram of an amplifier according to an embodiment of the present disclosure.

FIG. 9 is a circuit diagram of an analog-to-digital converter according to an embodiment of the present disclosure.

FIG. 10A is a circuit diagram of a temperature sensor and an acid-base sensor according to an embodiment of the present disclosure.

FIG. 10B is a partial cross-sectional view of an acid-base sensor according to an embodiment of the present disclosure.

FIG. 11A is an operating waveform diagram of a semiconductor sensing chip according to an embodiment of the present disclosure.

FIG. 11B illustrates a current waveform diagram of different redox currents.

FIG. 12 is an operating waveform diagram of a semiconductor sensing chip of the present disclosure.

FIG. 13A to FIG. 13E are diagrams of a manufacturing process of a microfluidics sensing system according to Embodiment 1 of the present disclosure.

FIG. 13F is a schematic diagram of a heater according to an embodiment of the present disclosure.

FIG. 14 is a temperature measurement diagram of a semiconductor sensing chip according to an embodiment of the present disclosure.

FIG. 15A is a waveform diagram of a peak value of a current difference under multiple sensing cycles in an embodiment of the present disclosure.

FIG. 15B is a waveform diagram of a peak value of a voltage difference under multiple sensing cycles in an embodiment of the present disclosure.

FIG. 16A and FIG. 16B are schematic diagrams of measurement of different concentration values in embodiments of the present disclosure.

FIG. 17 is a relationship diagram of CRISPR changes over time in a biofluid under test in an embodiment of the present disclosure.

### DETAILED DESCRIPTION OF DISCLOSED EMBODIMENTS

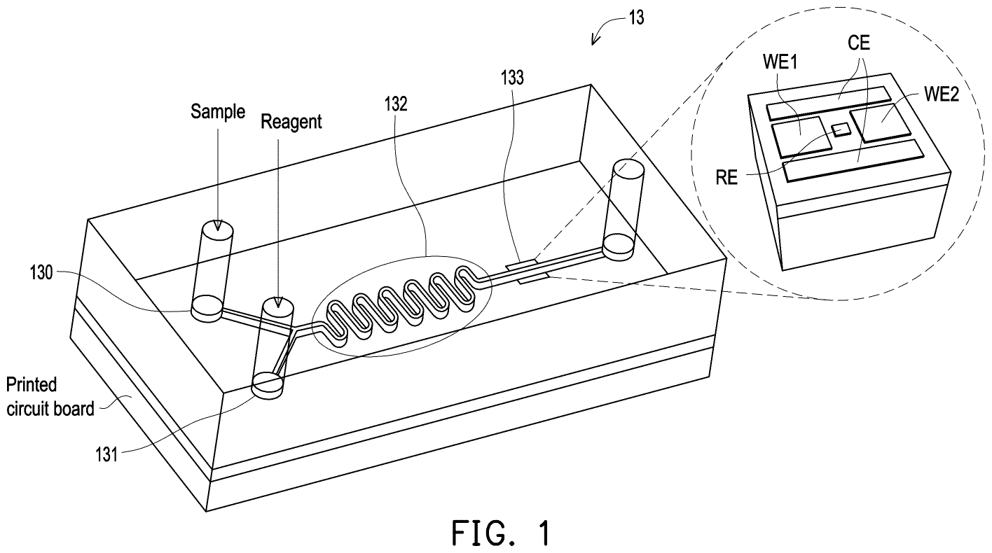

FIG. 1 shows a schematic diagram of a microfluidics sensing system 13 according to an embodiment of the present disclosure. Overall, the microfluidics sensing system 13 includes inlets 130 and 131, a fluidic structure 132 and a semiconductor sensing chip 133. The microfluidics sensing system 13 may integrate the fluidic structure 132 and the semiconductor sensing chip 133 into the miniaturized microfluidics sensing system 13. The inlets 130 and 131 may be configured for injection of samples and reagent respectively. The fluidic structure 132 may be coupled to inlets 130 and 131. The fluidic structure 132 may serve as a channel for a fluid to flow from the inlets 130 and 131 to the semiconductor sensing chip 133. In some embodiments, the fluidic structure 132 may have a channel design in a zigzag shape. In this way, in addition to the function of serving as channels, the fluidic structure132 may also serve the function of mixing and providing samples and reagent to generate a biofluid under test. The semiconductor sensing chip 133 is disposed at the end of the fluidic structure 132, and the biofluid under test formed after the sample and reagent are mixed may flow through the fluidic structure 132 to the surface of the semiconductor sensing chip 133. The semiconductor sensing chip 133 may be used to sense the biofluid under test and generate a concentration sensing result corresponding to the target biomolecule in the biofluid under test.

In some aspects, the microfluidics sensing system 13 combines many products of different fields such as the semiconductor chip 133, the fluidic structure 132, and a biosensor. Through structural and circuit design, the microfluidics sensing system 13 may be miniaturized to realize the application of POC.

In some aspects, biosensors are provided to convert biological reactions, especially the interaction between two molecules, into detectable electrical signals. Biosensors are commonly used in various fields, including medical diagnostics, environmental monitoring, food safety and biotechnology. There are many types of biosensors, including enzyme-based biosensors, biosensors that use DNA or RNA and the like, biosensors based on DNA or aptamers, or immune sensors that perform sensing based on antigen-antibody interactions, as well as nanomaterial-based and polymer-based biosensors utilizing nanoparticles, nanotubes or molecularly imprinted polymers, etc. for detecting the concentration of target molecules.

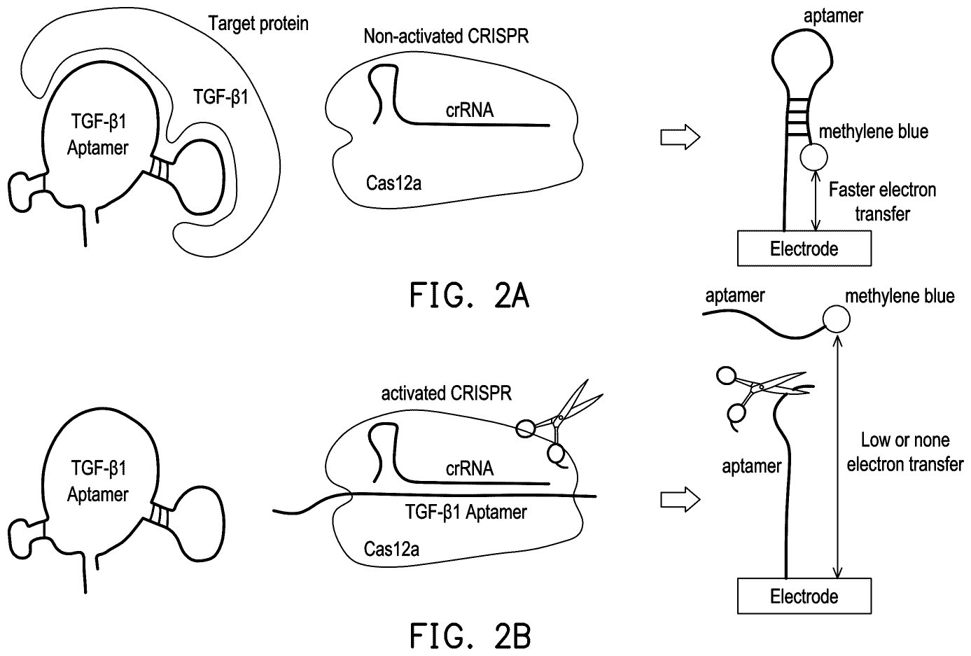

FIG. 2A and FIG. 2B illustrate a schematic diagram of the sensing principle of the microfluidics sensing system 13 in FIG. 1B.

Aptamers are “synthetic antibodies” composed of nucleic acids that may specifically bind target analytes in complex samples (such as whole blood). Importantly, aptamers may be designed as “aptamer switches” that reversibly switch structures upon target binding. By binding an electroactive reporter molecule to an aptamer, changes in its structure (and therefore, analyte concentration) may be detected electrochemically. Since no sample preparation is required, aptamer switches may simplify the measuring process. Taking the vancomycin aptamer as an example, binding to the target molecule facilitates a more thermodynamically stable stem-loop structure (folding) rather than a linear and flexible structure (unfolding). By binding the aptamer with the methylene blue (MB, C16H18CIN3S) reporter gene at the distal end of the DNA, the conformation change may be detected by measuring the sensitivity of the electron transfer (ET) difference between the MB and the underlying electrode to diffusion distance. When the MB is closer to the electrode, the highest electron migration kinetic energy occurs, resulting in a larger current when measured through square-wave voltammetry (SWV). In this way, a higher molecule concentration will cause more aptamers to convert into a stem-loop structure, resulting in a greater cumulative signal. In the system of the present disclosure, these aptamers are immobilized on chip electrodes to interface directly with biological fluids.

In some embodiments, the sample includes, but not limited to, blood, plasma, serum, saliva, urine, sweat, cerebrospinal fluid or other similar biological fluids, and the target molecules include hormones and metabolites, glucose, neurotransmitters or other similar biomolecules. The semiconductor sensing chip 133 may cooperate with the reagent to sense the concentration value of the target biomolecule contained in the sample. The reagent contains single-stranded DNA/RNA (aptamers) that bind to target molecules and detection enzymes. The detection enzyme may be a Clustered Regularly Interspaced Short Palindromic Repeat (CRISPR) enzyme with molecular scissor properties. For example, the metal carrier 11 may be made of gold (Au). The metal carrier 11 may be provided with deoxyribonucleic acid (DNA) that reacts with molecular scissors and is pre-labeled with a redox molecule, for example, methylene blue (MB). As shown in FIG. 2A, when the target biomolecule is a target protein and the target protein is present in the sample, the aptamer of the single-stranded DNA will bind to the target protein, reducing the amount of free single-stranded DNA in the biofluid under test. When these single-stranded DNA bind to the CRISPR enzyme, the molecular editing function of the CRISPR enzyme will be activated. Because the amount of free single-stranded DNA is small, the amount of single-stranded DNA with the labeling molecule methylene blue provided on the metal carrier 11 changes less, and the current signal received on the metal carrier 11 is greater.

In comparison, as shown in FIG. 2B, in the absence of target protein in the sample, there will be more free single-stranded DNAs that are not bound to the target protein in the biofluid under test. As a result, more CRISPR enzyme is activated with a molecular editing function, so that more single-stranded DNAs labeled with methylene blue will be cut by the CRISPR enzyme, causing the current signal received on the metal carrier 11 to weaken. In this way, the semiconductor sensing chip 1 may determine the concentration value of the target protein in the biofluid under test by the magnitude of the electrical signal sensed through the electrodes on the metal carrier 11.

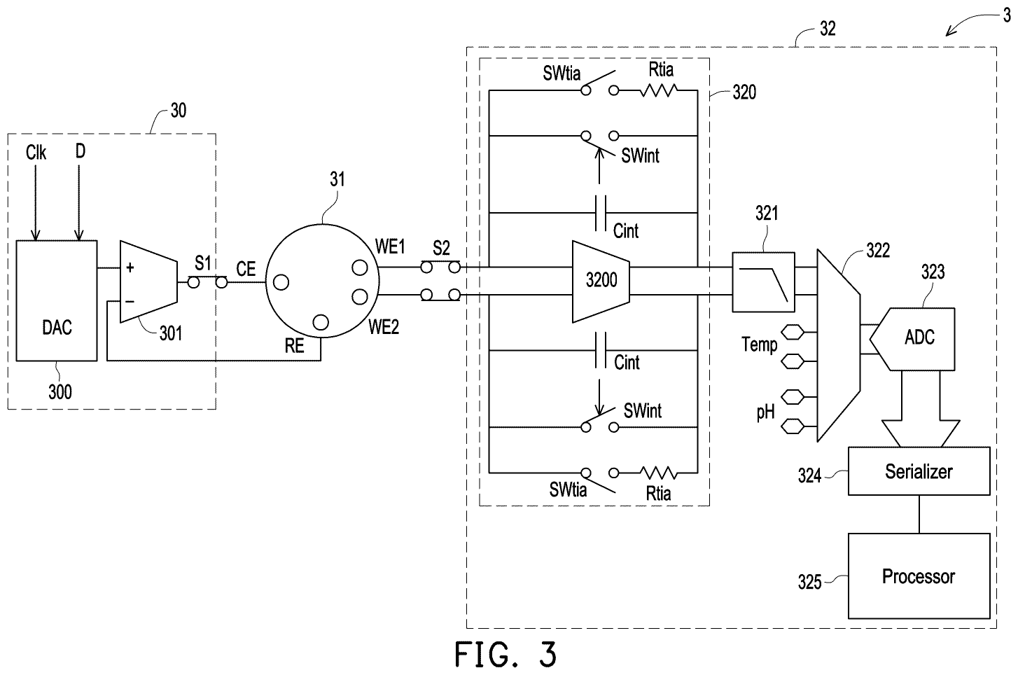

FIG. 3 is a block diagram of a semiconductor sensing chip 3 according to an embodiment of the present disclosure. The semiconductor sensing chip 3 may sense the concentration of specific target biomolecules in the biofluid under test through the bonding of Clustered Regularly Interspaced Short Palindromic Repeats (CRISPR) and aptamers. The semiconductor sensing chip 3 includes an input circuit 30, a metal carrier 31 and a readout circuit 32. The metal carrier 31 may be used to carry the biofluid under test formed by mixing the sample and the reagent. The semiconductor sensing chip 3 may carry the biofluid under test through the metal carrier 31 and perform testing, and sense the biofluid under test through the sensing electrodes WE1 and WE2 on the metal carrier 31. Furthermore, the semiconductor sensing chip 3 may accumulate the sensing signals through the readout circuit 32, and then obtain the concentration value corresponding to the specific protein in the biofluid under test through the peak signal of the accumulation result.

In some embodiments, the semiconductor sensing chip 3 may be used to provide an input signal S1 to the input electrode CE on the metal carrier 31 through the input circuit 30, thereby providing a continuously changing voltage stimulus to the biofluid under test. Moreover, the input circuit 30 may also use the negative feedback of the amplifier 301 to pull the feedback electrode RE to the same voltage level as the conversion signal of the digital-to-analog converter 300, and then stimulate the biofluid under test by sensing the voltage difference VWE-VRE between the sensing electrodes WE1 and WE2 and the feedback electrode RE. Furthermore, the semiconductor sensing chip 3 may perform sensing through the sensing electrodes WE1 and WE2 on the metal carrier 31 through the readout circuit 32 and obtain the sensing signal S2. In this way, the readout circuit 32 may accumulate the sensing signal S2 in each sensing cycle to generate an accumulation result, and determine the concentration value of the target biomolecule in the corresponding biofluid under test based on the accumulation result. For example, the sensing signal S2 may be a current signal, and the readout circuit 32 may accumulate the current as an accumulation signal, which may be used as a basis for judging the concentration value of the signal.

Specifically, the semiconductor sensing chip 3 includes an input circuit 30, a metal carrier 31 and a readout circuit 32. The input circuit 30 includes a digital-to-analog converter (DAC) 300 and an amplifier 301. The digital-to-analog converter 300 may convert the digital input control signal D into an analog conversion signal according to the clock signal Clk and provide the analog conversion signal to the positive input terminal of the amplifier 301. The output terminal of the amplifier 301 is coupled to the input electrode CE on the metal carrier 31. The amplifier 301 may be driven according to the conversion signal, then pull the voltage on the feedback electrode RE to be the same as the conversion signals provided by the digital-to-analog converter 30 through negative feedback, and then stimulate the biofluid under test by sensing the voltage difference VWE-VRE between the sensing electrodes WE1 and WE2 and the feedback electrode RE.

Further, the readout circuit 32 includes an integrator 320, a filter 321, a multiplexer 322, an analog-to-digital converter 323, a serializer 324 and a processor 325.

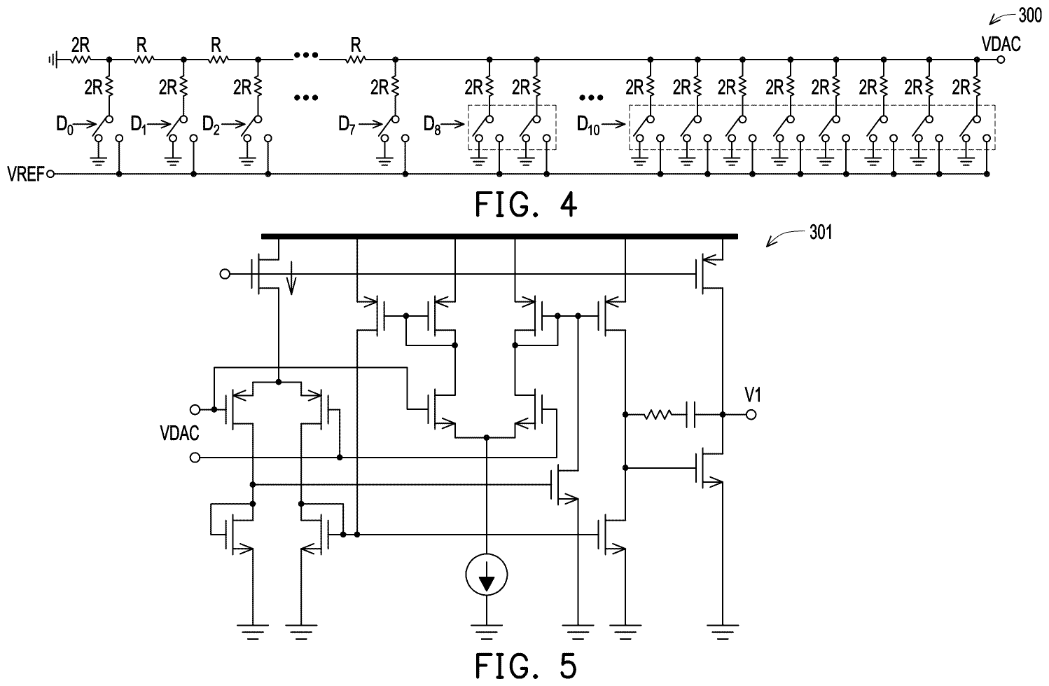

FIG. 4 is a circuit diagram of a digital-to-analog converter 300 according to an embodiment of the present disclosure. The digital-to-analog converter 300 in FIG. 4 is one implementation of the digital-to-analog converter 300 in FIG. 3. Specifically, the digital-to-analog converter 300 may, for example, convert an 11-bit input control signal into an analog voltage value. Each bit D₀ to D₁₀ of the input control signal D received by the digital-to-analog converter 300 may be used to control the corresponding switch to switch the corresponding resistor to be coupled to the reference voltage or the ground voltage VREF. In this embodiment, the eight smaller bits D₀ to D₇ of the input control signal D in the digital-to-analog converter 300 adopt an R-2R DAC architecture, and the three largest bits D₈ to D₁₀ adopt a DAC structure of a thermometer code, and therefore a conversion signal VDAC is generated at the upper right node. Through the above hybrid digital-to-analog converter architecture, a differential non-linearity (DNL) of +0.6/−0.65 minimum bit and an integral non-linearity (INL) of +1.48/−2.27 minimum bit may be achieved, taking into account the tradeoff between area and accuracy.

FIG. 5 is a circuit diagram of an amplifier 301 according to an embodiment of the present disclosure. The amplifier 301 in FIG. 5 is one implementation of the amplifier 301 in FIG. 3. In detail, the amplifier 301 is a two-stage amplifier with Miller compensation. The amplifier 301 has a double-ended input and a single-ended output, and the output of the amplifier 301 may generate a 200 millivolt step signal at maximum with a settling time of 200 microseconds. Moreover, through the negative feedback coupling method as shown in FIG. 3, the amplifier 301 may be operated as a potentiostat or a unit gain buffer.

Please refer to FIG. 3 again. In this embodiment, the integrator 320 has a double-ended structure. The following will describe the structure and operation of a single side of the integrator 320. Those with ordinary knowledge in the art may deduce a double-ended operation of the integrator 320 based on the following. In detail, the integrator 320 includes an amplifier 3200, a capacitor Cint, a resistor Rtia, and switches SWint and SWtia. The capacitor Cint and the switch SWint are connected in parallel between the input terminal and the output terminal of the amplifier 3200. The resistor Rtia is connected in series to the switch SWtia, and the series connection of the two is also connected in parallel between the input terminal and the output terminal of the amplifier 3200. Under some operating conditions, when the switches SWint and SWtia are both open circuit or non-conducting, the current flowing into the input terminal will flow to the upper plate of the capacitor Cint, so that the amplifier 3200 and the capacitor Cint may operate together in the form of an integrator. Accordingly, the amplifier 3200 may accumulate the received electrical signal (e.g., current or charge) on the capacitor Cint, and reset the voltage stored on the capacitor Cint each time the switch SWint is turned on or conducted. Under some operating conditions, when the switch SWtia is turned on or conducted, the resistor Rtia may be connected in parallel to the amplifier 3200, so that the amplifier 3200 may operate in a transimpedance amplifier mode, which may convert the received current to voltage to provide the back-end circuit with real-time interpretation of the magnitude of the current of the sensing signal S2.

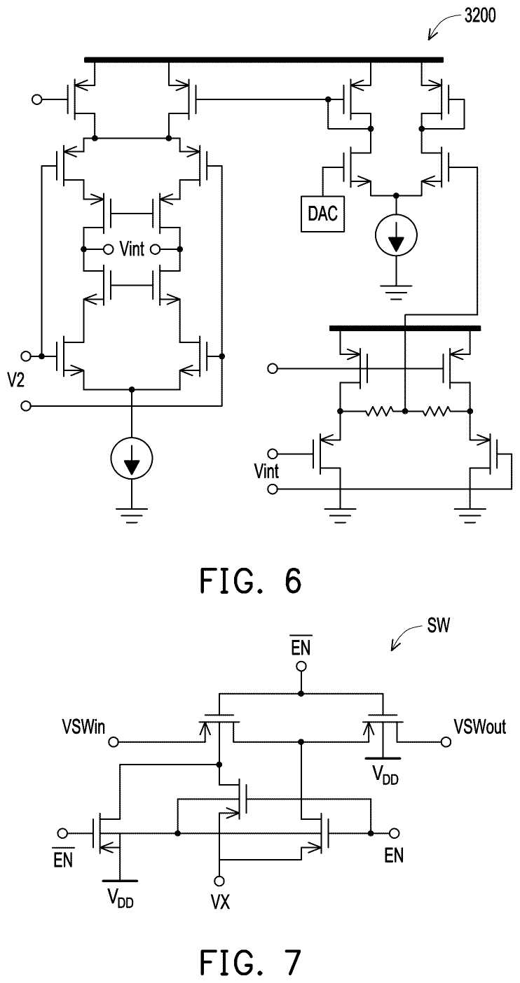

FIG. 6 is a circuit diagram of an amplifier 3200 according to an embodiment of the present disclosure. The amplifier 3200 in FIG. 6 is one implementation of the amplifier 3200 in FIG. 3. As shown in FIG. 6, the amplifier 3200 is applied in the integrator 320 to receive the sensing signal S2 to generate the output signal Vint. The amplifier 3200 is a telescopic amplifier with a current reuse architecture. The main structure of the amplifier on the left is used to receive the input signal and generate an output signal. The common mode feedback circuit on the right is adopted to stabilize the common mode voltage level at the output terminal of the amplifier 3200 to a specific voltage level through feedback.

FIG. 7 is a circuit diagram of the switch SW according to the embodiment of the present disclosure. The amplifier SW in FIG. 7 is one implementation of any one of the switches SWint and SWtia in FIG. 3. As shown in FIG. 7, the switch SW has an input terminal and an output terminal, respectively adopted to receive the input signal VSWin and provide the output signal VSWout. Whether the input terminal and the output terminal are connected or not may be controlled by the enable signal EN on the control terminal. In addition, the switch SW as a whole may also receive the bias voltage VX and the operating voltage V_{DD} to be biased in an appropriate operating state. Therefore, the switch SW may have low leakage characteristics, thereby ensuring that the data stored on the capacitor Cint is correct and will not be affected by leakage current when the amplifier 3200 and the capacitor Cint are operated in the integrator.

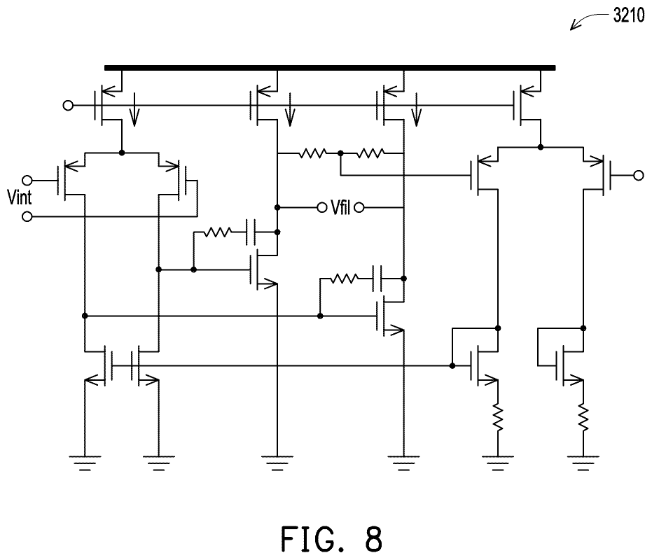

FIG. 8 is a circuit diagram of an amplifier 3210 according to an embodiment of the present disclosure. In an embodiment, the filter 321 may be an analog filter, and the amplifier 3210 in FIG. 8 may be used in the filter 321 in FIG. 3 as one of the implementations. Specifically, the amplifier 3210 is a two-stage amplifier with Miller compensation. The filter 321 applied with the amplifier 3210 may have a gain range of 0 to 40 decibels (dB), and the frequency band or bandwidth of the signal passing through may be 100 kilohertz to 10 kilohertz (kHz). The amplifier 3210 may receive the signal Vint generated by the integrator 320 as an input and generate an output signal Vfil.

FIG. 9 is a circuit diagram of an analog-to-digital converter 323 according to an embodiment of the present disclosure. The analog-to-digital converter 323 in FIG. 9 is one implementation of the analog-to-digital converter 323 in FIG. 3. As shown in FIG. 9, the analog-to-digital converter 323 is a successive approximation ADC (SAR ADC). The analog-to-digital converter 323 has an input terminal for receiving the signals Vfil1 and Vfil2 provided by the filter 321 and converting the received signals into a digital output signal Dout. The analog-to-digital converter 323 has a plurality of capacitors connected in parallel, and the capacitance value of the capacitors increases quadratically with the magnitude of the control bit. Each capacitor is connected in series to a corresponding switch, and the switch is controlled by the bit of the corresponding control signal and switches between the reference voltages Vrefp and Vrefn and the common mode voltage Vcm.

When the analog-to-digital converter 323 receives the input analog signal, the SAR logic circuit in the analog-to-digital converter 323 may generate a control signal. The comparator is adopted for comparison and the switch is controlled using a binary approximation algorithm. By switching capacitors bit by bit, it is possible to approximate the magnitude of the input analog signal. In this embodiment, the analog-to-digital converter 323 has a resolution of ten bits and an effective number of bits (ENOB) of 9.4 bits.

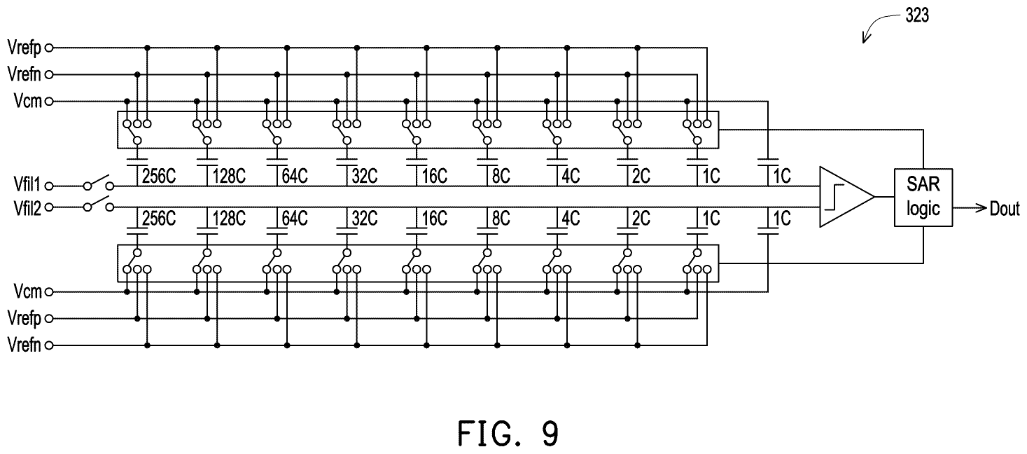

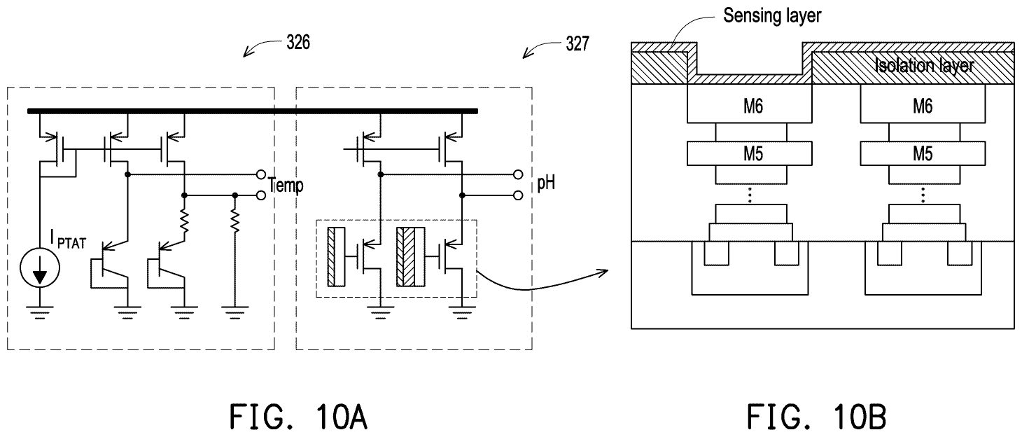

FIG. 10A is a circuit diagram of a temperature sensor 326 and an acid-base sensor 327 according to an embodiment of the present disclosure. Although not explicitly shown in FIG. 3, the temperature sensor 326 and the acid-base sensor 327 in FIG. 10A may be applied to the semiconductor sensing chip 3 in FIG. 3 and coupled to the front end of the multiplexer 322. The outputs of the temperature sensor 326 and the acid-base sensor 327 may be switched by the multiplexer 322 to be input to the analog-to-digital converter 323 at an appropriate time and converted into a digital output value, and then provided to the processor 325 as a reference for judging the concentration values. Specifically, the temperature sensor 326 is a temperature sensor that is realized based on the characteristics of a bipolar junction transistor (BJT), and generates an output signal Temp related to temperature information through the characteristics of the temperature sensor 326 relative to temperature changes.

The acid-base sensor 327 in FIG. 10A may have a sensing transistor and a reference transistor. FIG. 10B is a partial cross-sectional view of the acid-base sensor 327 according to the Embodiment 1 of the present disclosure. The cross-sectional view of the sensing transistor and the reference transistor may be shown in FIG. 10B. The sensing transistor has a sensing area on the electrode connected to the gate, so that the sensing transistor may generate a corresponding voltage signal according to the pH value of the contacted biofluid under test in the sensing area. In addition, the reference transistor has an additional passivation layer on the electrode connected to the gate, which may reduce the sensitivity of the reference transistor to changes in the pH value. Therefore, the pH value information of the biofluid under test may be obtained by reading the voltage output by the acid-base sensor 327.

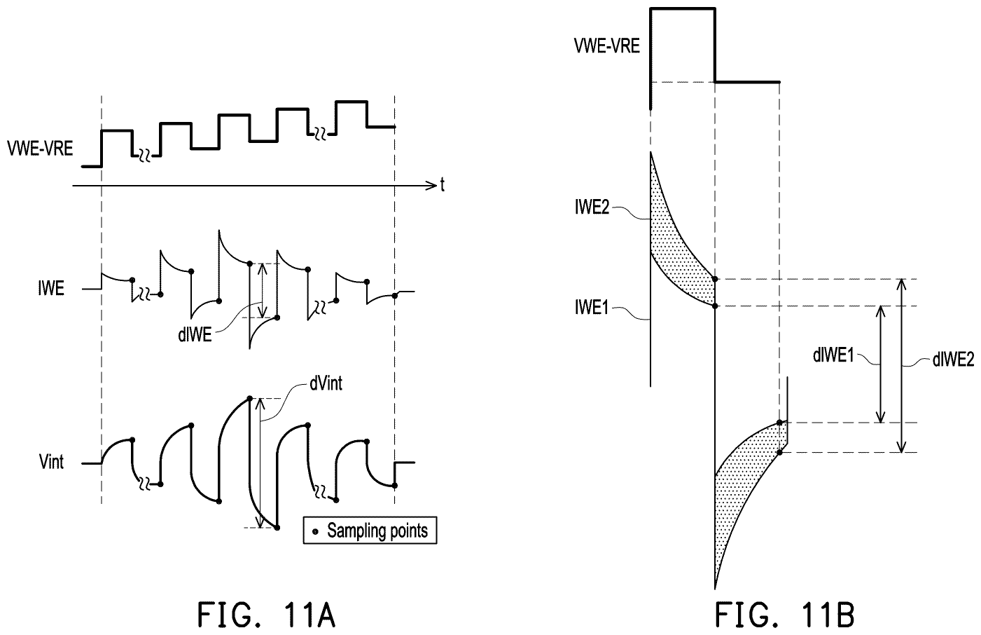

FIG. 11A is an operating waveform diagram of the semiconductor sensing chip 3 according to an embodiment of the present disclosure. The uppermost part of FIG. 11A shows the voltage difference between the sensing electrode WE and the feedback electrode RE generated by the input signal S1 provided by the input circuit 30. As shown in FIG. 11A, the input signal provided by the input circuit 30 will rise step by step. There are multiple pulse square waves in the input signal, and the DC voltage level of each pulse square wave gradually increases. Such input signal method is also called square-wave voltammetry (SWV), which may be used in electrochemistry and other suitable fields to obtain changes in redox current by providing square wave pulses with gradually increased potential.

The middle part of FIG. 11A shows the waveform diagram of the redox current IWE of the biofluid under test measured by the sensing electrode WE. Generally speaking, with the input of a square wave, the redox current IWE of the biofluid under test will have a greater current value at the rising edge of the square wave. Moreover, as the input square wave is maintained at a high voltage level, the redox current IWE of the biofluid under test will decay exponentially, causing the difficulty of sensing by the semiconductor sensing chip 3 and increasing the hardware cost.

FIG. 11B shows the current waveform diagrams of different redox currents IWE1 and IWE2. As shown at the top of FIG. 11B, the analog-to-digital converter 323 in the semiconductor sensing chip 3 performs sampling according to the input signal, that is, sampling is performed at each rising and falling edge of the input signal. As shown at the bottom of FIG. 11B, by sampling the redox currents IWE1 and IWE2 according to the edges of the input signal, the redox current differences dIWE1 and dIWE2 corresponding to each half sensing cycle may be obtained. As shown in FIG. 11B, the redox currents IWE1 and IWE2 initially have a maximum current value in each half sensing cycle, and then exhibit exponential decay. Therefore, the current values of the redox currents IWE1 and IWE2 each time they are sampled will be close to the minimum current value of each half sensing cycle, and the corresponding calculated redox current differences dIWE1 and dIWE2 will also be relatively small. In this way, if it is desired to obtain the concentration value of the corresponding target biomolecule in the biofluid under test by interpreting and measuring the magnitude of the redox current IWE or the redox current differences dIWE1 and dIWE2, a more accurate analog-to-digital converter 323 with a high tolerance for noise is required at the back end of the semiconductor sensing chip 3.

Please refer again to the bottom part of FIG. 11A, which shows the waveform diagram of the output voltage Vint of the integrator 320. Specifically, the integrator 320 may receive the redox current IWE and integrate the redox current IWE in each half sensing cycle. In this way, the integrator 320 may accumulate the redox current IWE to generate the output voltage Vint. Different from the redox current IWE, the current magnitude and half-cycle current difference of the redox current IWE will decay exponentially before sampling. The output voltage Vint generated by the integrator 320 will continue to increase or decrease before sampling. In addition to the increasing voltage of the output voltage Vint, the difference between different redox currents IWE will also be accumulated in the output voltage Vint generated by different redox currents IWE, so that the voltage difference dVint between the output voltages Vint generated by different redox currents IWE will also increase in the half sensing cycle.

Specifically, please refer to FIG. 11B. The integrator 320 will accumulate different redox currents IWE1 and IWE2, so that the voltage difference of the generated output signal will correspond to the area difference between the redox currents IWE1 and IWE2. As long as the redox currents IWE1 and IWE2 maintain a constant relative relationship during the half sensing cycle (that is, the redox current IWE1 is always greater than the redox current IWE2, or the redox current IWE1 is always less than the redox current IWE2), the voltage difference of the output signal Vint generated according to the redox currents IWE1 and IWE2 will continue to increase. Such sensing method is also called Square-Wave Voltcoulometry (SWVC). In this way, the continuously increased voltage difference requires lower accuracy for the back-end analog-to-digital converter 323, thereby effectively reducing the area and cost of the semiconductor sensing chip 3, thereby facilitating the miniaturization of the semiconductor sensing chip 3.

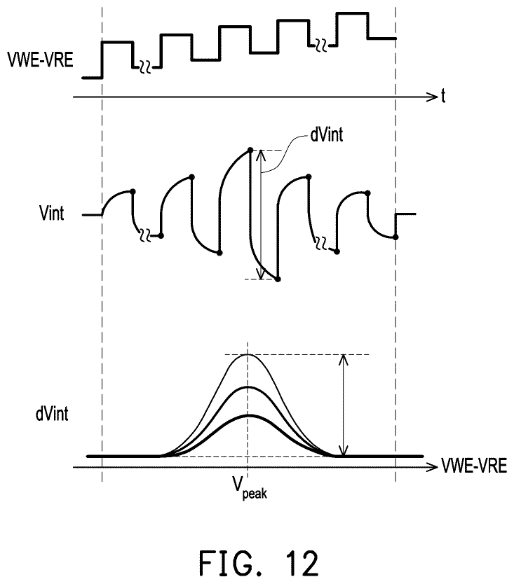

FIG. 12 is an operating waveform diagram of a semiconductor sensing chip 3 of the present disclosure. The uppermost part of FIG. 12 shows the same input signal waveform diagram as the uppermost part of FIG. 11A. The middle part of FIG. 12 shows the same waveform diagram of the output signal Vint of the integrator 320 as the bottom part of FIG. 11A. Furthermore, the analog-to-digital converter 323 samples each rising and falling edge of the input signal, and provides the sampled voltage value to the processor 325 through a serial circuit 324. The processor 325 may calculate the voltage difference dVint of the output signal Vint in each sensing cycle based on the provided voltage value, and generate the voltage difference dVint variation waveform diagram in the bottom part of FIG. 12 based on the voltage difference dVint. In the waveform diagram at the bottom, the vertical axis is voltage and the horizontal axis is VWE-VRE.

Generally speaking, the chemical changes in the biofluid under test will gradually intensify and then slow down as time goes by. Therefore, the relationship between the sampled voltage difference dVint and the voltage VWE-VRE will be as shown in FIG. 12 like a bell. The processor 325 may measure the peak value in the waveform diagram to determine the concentration value of the target biomolecule in the biofluid under test. Specifically, the processor 325 stores a concentration comparison table, which records the corresponding relationship between the peak value of the voltage difference dVint and the target biomolecule concentration. Therefore, the processor 325 may look up the concentration comparison table based on the peak value of the voltage difference dVint to obtain the concentration value of the target biomolecule in the biofluid under test.

In some embodiments, the concentration comparison table may further record the corresponding relationship between the peak value of the voltage difference dVint as well as the temperature and the pH value of the biofluid under test and the concentration thereof. In this way, the semiconductor sensing chip 3 may further be provided with a temperature sensor and an acid-base sensor, and the processor 325 may jointly find the concentration value of the target biomolecule based on the temperature and pH value of the biofluid under test sensed by the temperature sensor and the acid-base sensor as well as the peak value of the voltage difference dVint. In other words, the processor 325 may retrieve the correct concentration value of the target biomolecule by looking up the concentration comparison table through the sensed temperature and pH value.

In some embodiments, the processor 325 may be, for example, a central processing unit (CPU), or other programmable general-purpose or specific-purpose micro control unit (MCU), microprocessor, digital signal processor (DSP), a programmable controller, an application specific integrated circuit (ASIC), a graphics processing unit (GPU), an arithmetic logic unit (ALU), a complex programmable logic device (CPLD), a field programmable gate array (FPGA), any other type of integrated circuit, a state machine, a processor based on advanced RISC Machine (ARM), or other similar components or a combination of the above components.

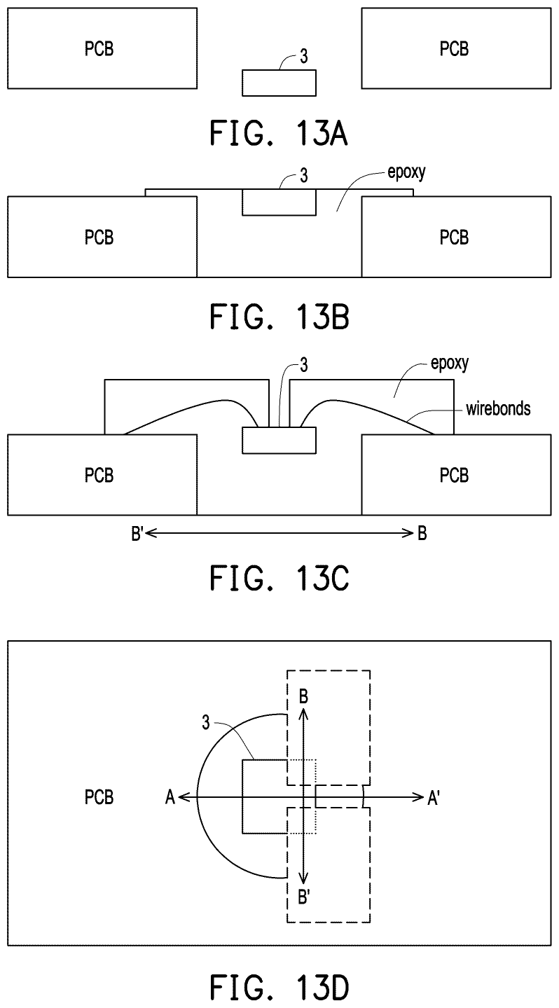

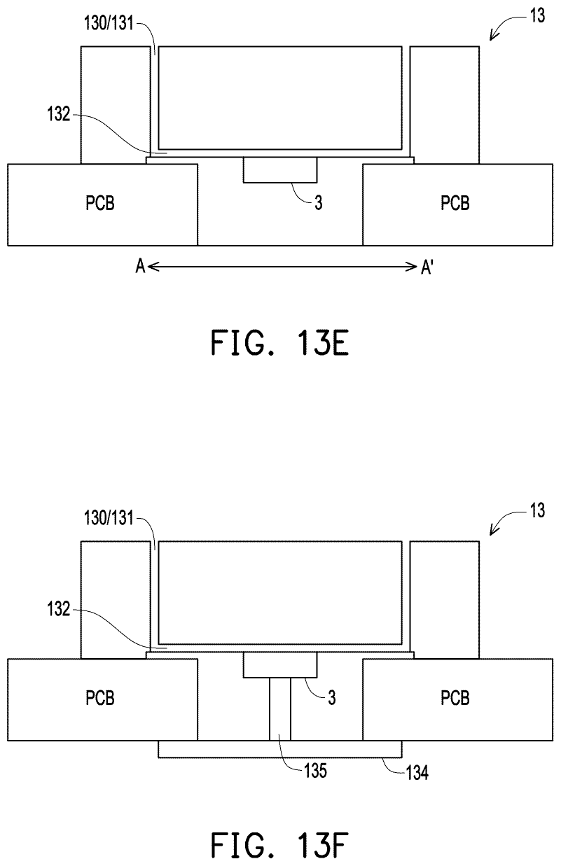

FIG. 13A to FIG. 13E are diagrams of the manufacturing process of a microfluidics sensing system 13 according to an embodiment of the present disclosure. The manufacturing process of FIG. 13A to FIG. 13E may be used to manufacture, for example, the microfluidics sensing system 13 in FIG. 1.

Specifically, before performing the resin injection process in FIG. 13A, the sensing electrodes are disposed on the metal carrier. First, the metal carrier is plated with about 2 μm to 3 μm thick gold using a process technology such as electroless nickel immersion gold (ENIG); then a larger area of gold coating is coated on the surface of the chip by using photomask and etching technology supplemented by electron beam evaporation (E-gun), and the thickness of this layer is, for example, about 200 nm, and the preparation of sensing electrode is completed at this stage.

In FIG. 13A, an inverted printed circuit board and semiconductor sensing chip are provided. The semiconductor sensing chip may be, for example, the semiconductor sensing chip 133 in FIG. 1 or the semiconductor sensing chip 3 in FIG. 3. Because the semiconductor sensing chip is up-side-down, the metal carrier in the semiconductor sensing chip 3 and the traces on the printed circuit board will face downward. In more detail, the semiconductor sensing chip 3 is placed in the opening of the printed circuit board. In a subsequent step, a base such as epoxy is injected into the opening of the printed circuit board. In some embodiments, the chip is placed on some removable bases and epoxy is then injected. The removable base is, for example, a polyimide film tape (also known as Kapton tape), or other suitable materials.

After the microfluidic channel and printed circuit board are assembled, and before sensing the biofluid under test, the electrodes on the semiconductor sensing chip will be functionalized through the biosensor. Biosensor immobilization involves attaching biometric components (such as enzymes, antibodies, nucleic acids or cells) to the surface of the electrode. Attachment methods include adsorption, covalent binding, cross-linking, affinity binding, etc. For example, the attachment may be performed based on thiol-gold interactions, in which the thiol group is bound to the 5′- or 3′-end of DNA or RNA, and the thiol is adsorbed onto the surface of the gold electrode by incubation with a gold electrode. Before this step, the electrode must be thoroughly cleaned. Cleaning may be performed through a variety of methods, including solvent cleaning, electrochemical cleaning, plasma cleaning, and combinations of the above methods.

In FIG. 13B, after the epoxy is injected into the opening of the printed circuit board, the printed circuit board and the semiconductor sensing chip 3 will be turned over. It may be observed that on the semi-finished product, the semiconductor sensing chip 3 and the epoxy will be coplanar with each other, forming a flat surface together.

In FIG. 13C, appropriate bonding wires are performed between the semiconductor sensing chip 3 and the printed circuit board. The epoxy will be poured on the surface of the semiconductor sensing chip 3 for a second time to cover and protect the wiring structure.

FIG. 13D shows a top view of the semi-finished microfluidics sensing system after the second pouring of epoxy. As shown by the dashed line in FIG. 13D, the epoxy that is poured for the second time will only cover the two corners on the same side of the semiconductor sensing chip 3, other than exposing the metal carrier disposed on the other side of the semiconductor sensing chip 3, it is also possible to retain the fluidic structure 132 and the trench through which the biofluid under test passes between the two corners on the side where the epoxy is poured for the second time. Therefore, the cross-sectional view shown in FIG. 13C will correspond to line B-B′ in FIG. 13D.

In FIG. 13E, a structural material such as polydimethylsiloxane is disposed on the semiconductor sensing chip 3 and the epoxy, and a fluidic structure 132 that passes through the surface of the semiconductor sensing chip 3 is disposed in the structural material. In detail, FIG. 13E is a cross-sectional view along line A-A′in FIG. 13D. In order to facilitate understanding and description of the fluidic structure 132, the sizes and shapes of some components in FIG. 13E are only for reference and are not intended to limit the implementation. Specifically, the semiconductor sensing chip 3 and the epoxy will be coplanar in the direction along the line A-A′. In this way, when the fluidic structure 132 is further disposed on the semiconductor sensing chip 3 and the epoxy, the fluidic structure 132 may be formed on a flat plane without being bent because of the ups and downs and affect the mixing and flow of the biofluid under test.

FIG. 13F is a schematic diagram of a heater 134 in an embodiment of the present disclosure. In FIG. 13F, in some embodiments, an additional heater 134 may be provided below the semiconductor sensing chip 3 in the microfluidics sensing system 13. The heater 134 may be used to heat the semiconductor sensing chip 3 through a thermal hole 135 filled with a thermally conductive material (such as thermal paste or metal) under the semiconductor sensing chip 3. Specifically, in the embodiment where the reagent contains CRISPR enzyme, since the ideal temperature for CRISPR enzyme is 37° C., the processor and the temperature sensor in the semiconductor sensing chip 3 jointly feedback to control the heating power of the heater 134 so as to heat the temperature of the semiconductor sensing chip 3 to an appropriate preset temperature range. In some embodiments, the heater 134 may also be integrated in the semiconductor chip 3 rather than heating the semiconductor chip 3 externally.

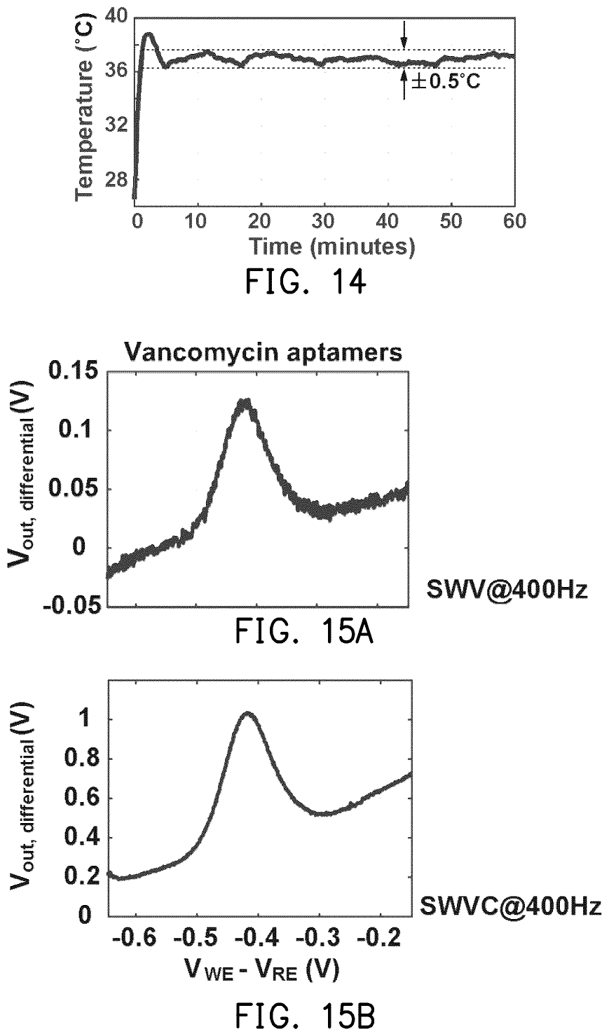

FIG. 14 is a temperature measurement diagram of the semiconductor sensing chip 3 according to an embodiment of the present disclosure. As shown in FIG. 14, after the semiconductor sensing chip 3 is activated and starts to operate, the heater 134 may heat the semiconductor sensing chip 3. Moreover, after being heated to the preset temperature, according to the control of the processor, the temperature of the semiconductor sensing chip 3 may be controlled within the preset temperature range, which better facilitates the sensing performed by the microfluidics sensing system 13.

FIG. 15A is a waveform diagram of the peak value of the current difference dIWE under multiple sensing cycles in an embodiment of the present disclosure. FIG. 15B is a waveform diagram of the peak value of the voltage difference dVint under multiple sensing cycles in an embodiment of the present disclosure. Specifically, the current difference dIWE in FIG. 15A may be derived by referring to the middle part of FIG. 11A, for example, obtained by converting the current value of the sensing signal S2 into a voltage by the integrator 320 operating in the transimpedance amplifier mode, that is, obtained through the square-wave voltammetry (SWV). In comparison, the voltage difference in FIG. 15B is obtained, for example, by integrating the current of the sensing signal S2 by the integrator 320 operating in the integrator mode, that is, obtained by the square-wave voltcoulometry method (SWVC). Comparing FIG. 15A and FIG. 15B, it can be seen that the voltage waveform obtained by the square-wave voltcoulometry method (SWVC) has a larger amplitude, and the waveform diagram has lower noise disturbance. Therefore, the sensing results obtained by the square-wave voltcoulometry method (SWVC) have better resistance to noise and have better signal resolution.

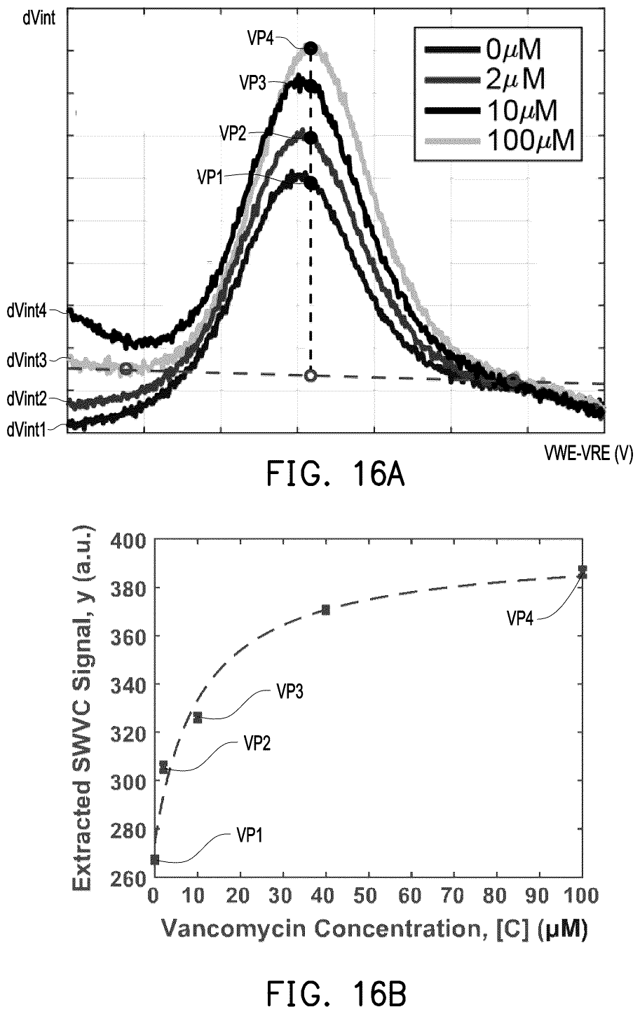

FIG. 16A and FIG. 16B are schematic diagrams of measurement of different concentration values in embodiments of the present disclosure. FIG. 16A shows the voltage differences dVint1 to dVint4 obtained in each measurement based on different concentration values. It can be seen that the peak values VP1 to VP4 of the voltage differences dVint1 to dVint4 gradually increase as the concentration of the target biomolecule increases.

In FIG. 16B, the horizontal axis represents the concentration value and the vertical axis represents the magnitude of the voltage difference. As shown in FIG. 16B, the peak values VP1 to VP4 obtained at different concentrations of target biomolecules will satisfy the relationship curve between concentration value and voltage difference. Therefore, the processor may look up the concentration comparison table based on the peak values VP1 to VP4 to obtain the concentration value of the target biomolecule at each voltage difference.

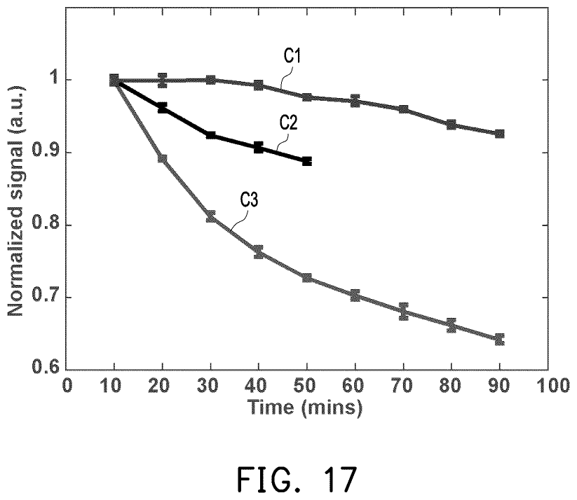

FIG. 17 is a relationship diagram of CRISPR changes over time in the biofluid under test in an embodiment of the present disclosure. The horizontal axis is time and the vertical axis is the concentration ratio normalized by the initial concentration. In the example of FIG. 17, the prepared CRISPR enzyme was mixed with single-stranded DNA (that is, aptamer) with concentrations of 0 nM, 0.65 nM and 6.5 nM at 25° C. for 10 minutes to form different amounts of Cas12a-RNA-DNA triplex. Next, these triplexes were incubated with the reporter aptamer at 37° C. to activate their gene editing function, and the concentration results of the CRISPR enzyme were monitored every 10 minutes. FIG. 17 shows curves C1 to C3, corresponding to changes in the concentration of CRISPR enzyme in single-stranded DNA aptamers with concentrations of 0 nM, 0.65 nM, and 6.5 nM respectively. As shown in FIG. 17, as the concentration of single-stranded DNA aptamer is different, the concentration of CRISPR enzyme also changes differently. In some embodiments, when 30 minutes have elapsed, the concentration change of CRISPR enzyme is sufficient to determine the concentration value of the target biomolecule. Therefore, the sensing mechanism of target biomolecules of the present disclosure may also improve the feasibility of applying the present disclosure to POC.

In some embodiments, the processor may be disposed in a semiconductor sensing chip. In some embodiments, the processor may be separated from the semiconductor sensing chip and disposed on a printed circuit board outside the semiconductor sensing chip, and connected to the semiconductor sensing chip through bonding wire.

In summary, the present disclosure achieves the miniaturization of the semiconductor sensing chip and the microfluidics sensing system through the fluidic structure arrangement in the microfluidics sensing system and the readout circuit in the semiconductor sensing chip to accumulate sensing signals. Compared with conventional test strips that are only able to provide binary test results, or the large-scale testing machines that have relatively high costs, the microfluidics sensing system and semiconductor sensing chip of the present disclosure may achieve the target biomolecule concentration judgment results with a higher accuracy at a lower cost.

What is claimed is:

1. A microfluidics sensing system, comprising:
a first inlet and a second inlet respectively configured for injection of a sample and a reagent;
a fluidic structure coupled to the first inlet and the second inlet, wherein the fluidic structure is configured to mix the sample and the reagent to generate a biofluid under test; and
a semiconductor sensing chip configured at an end of the fluidic structure and configured to sense the biofluid under test and generate a concentration sensing result corresponding to the sample.

2. The microfluidics sensing system according to claim 1, wherein the fluidic structure has a zigzag-shaped channel structure.

3. The microfluidics sensing system according to claim 1, wherein the sample comprises at least one of blood, plasma, serum, saliva, urine, sweat, and cerebrospinal fluid.

4. The microfluidics sensing system according to claim 1, wherein the reagent comprises an aptamer and a detection enzyme, wherein the aptamer is configured to bind to a target biomolecule in the sample or activate the detection enzyme.

5. The microfluidics sensing system according to claim 4, wherein the aptamer is a single-stranded deoxyribonucleic acid (DNA), the detection enzyme is a Clustered Regularly Interspaced Short Palindromic Repeat (CRISPR) enzyme, and the target biomolecule comprises at least one of proteins, hormones and metabolites, glucose, and neurotransmitters.

6. The microfluidics sensing system according to claim 4, wherein the semiconductor sensing chip comprises a metal carrier for carrying the biofluid under test, wherein a sensing electrode of the metal carrier is provided with a detection DNA pre-labeled with a redox molecule, the activated detection enzyme is configured to perform modification on the detection DNA.

7. The microfluidics sensing system according to claim 6, wherein the semiconductor sensing chip determines a concentration value of the target biomolecule in the sample by detecting a magnitude of a sensing current between the detection DNA and the sensing electrode.

8. The microfluidics sensing system according to claim 7, wherein the higher the concentration value of the target biomolecule in the sample is, the greater the sensing current received by the semiconductor sensing chip through the sensing electrode is, the lower the concentration value of the target biomolecule in the sample is, the smaller the sensing current received by the semiconductor sensing chip is.

9. The microfluidics sensing system according to claim 1, further comprising:
a base surrounding the semiconductor sensing chip, wherein the base is coplanar with the semiconductor sensing chip.

10. The microfluidics sensing system according to claim 1, further comprising:
a heater configured in the microfluidics sensing system and away from a lower surface of the semiconductor sensing chip, and configured to heat the semiconductor sensing chip to a preset temperature range.

11. A semiconductor sensing chip, configured to sense a biofluid under test, wherein the semiconductor sensing chip comprises:
a metal carrier having a sensing electrode, wherein the metal carrier is configured to carry the biofluid under test and sense the biofluid under test through the sensing electrode to obtain a sensing signal; and
a readout circuit configured to accumulate the sensing signal in a preset time interval to generate an accumulation result, wherein the readout circuit generates a concentration value corresponding to the biofluid under test based on the accumulation result.

12. The semiconductor sensing chip according to claim 11, wherein the readout circuit comprises an integrator, the integrator is configured to integrate the sensing signal in the preset time interval to generate the accumulation result, thereby obtaining the accumulation result through a square-wave voltcoulommetry (SWVC) method.

13. The semiconductor sensing chip according to claim 12, wherein the readout circuit comprises:
an analog-to-digital converter (ADC) coupled to the integrator, and configured to convert the accumulation result from analog to digital; and
a processor coupled to the analog-to-digital converter, and configured to determine the concentration value based on the converted accumulation result.

14. The semiconductor sensing chip according to claim 13, wherein the processor further stores a concentration comparison table, and the processor is configured to look up the concentration comparison table according to the converted accumulation result to look up the corresponding concentration value.

15. The semiconductor sensing chip according to claim 11, wherein the metal carrier comprises an input electrode, and the semiconductor sensing chip comprising:
an input circuit configured to generate an input signal which rises step by step and stimulate the biofluid under test according to the input signal.

16. The semiconductor sensing chip according to claim 11, wherein a reagent comprises an aptamer and a detection enzyme, wherein the aptamer is configured to bind to a target biomolecule in a sample or activate the detection enzyme.

17. The semiconductor sensing chip according to claim 16, wherein the aptamer is a single-stranded deoxyribonucleic acid (DNA), the detection enzyme is a Clustered Regularly Interspaced Short Palindromic Repeat (CRISPR) enzyme, and the target biomolecule is a target protein.

18. The semiconductor sensing chip according to claim 16, wherein the sensing electrode of the metal carrier is provided with a detection DNA pre-labeled with methylene blue (MB), the activated detection enzyme is configured to perform modification on the detection DNA.

19. The semiconductor sensing chip according to claim 18, wherein the semiconductor sensing chip determines a concentration value of the target biomolecule in the sample by detecting a magnitude of a sensing current between the detection DNA and the sensing electrode.

20. The semiconductor sensing chip according to claim 19, wherein the higher the concentration value of the target biomolecule in the sample is, the greater the sensing current received by the semiconductor sensing chip through the sensing electrode is, the lower the concentration value of the target biomolecule in the sample is, the smaller the sensing current received by the semiconductor sensing chip is.
